(19) United States
(12) Patent Application Publication
(10) Pub. No.: US 2009/0014163 A1
(43) Pub. Date: Jan. 15, 2009

(54) Temperature Controlled Pipe Systems And Methods

(76) Inventor: Rod Thomas, Earth City, MO (US)

Correspondence Address: LATHROP & GAGE LC, 4845 PEARL EAST CIRCLE, SUITE 300, BOULDER, CO, 80301, US

(21) Appl. No.: 12/233,426

(22) Filed: Sep. 18, 2008

Related U.S. Application Data
(63) Continuation-in-part of application No. 12/109,108, filed on Apr. 24, 2008.
(60) Provisional application No. 60/913,727, filed on Apr. 24, 2007.
(60) Provisional application No. 60/939,070, filed on May 20, 2007.

(51) Int. Cl. F28D 7/10; G05D 23/19; G05D 23/00

(52) U.S. Cl. 165/154; 165/287; 700/299

(57) ABSTRACT

A temperature controlled piping system has at least one pipe section having: an outer pipe; and an inner pipe generally concentric to the outer pipe for transporting temperature sensitive fluid therethrough, the outer and inner pipes forming therebetween at least one temperature control space; such that transmission of temperature controlled fluid through the temperature control space influences temperature of the temperature sensitive fluid flowing through the inner pipe.

### RELATED APPLICATIONS

This application is a continuation-in-part of U.S. application Ser. No. 12/109,108, filed Apr. 24, 2008, which claims the benefit of priority to U.S. Provisional Patent Application Ser. Nos. 60/913,727, filed Apr. 24, 2007, and 60/939,070, filed May 20, 2007. Each of these applications is incorporated by reference herein.

### FIELD OF INVENTION

The present disclosure relates generally to temperature controlled piping, and specifically to prefabricated multi-chamber vacuum insulated pipe sections that may controllably pass through fluid, for example to provide freeze-free water pipes.

### BACKGROUND

Insulated pipes are used in a wide variety of industrial applications to prevent thermal leakage. For example, thermally insulated piping is used to transport cryogenic liquids. There are three types of commonly used insulated piping: foam insulated copper pipe, dynamic vacuum insulated pipe and static vacuum insulated pipe.

Foam insulated copper pipe is one type of prefabricated pipe with sections constructed of copper surrounded by foam insulation. While foam insulated copper pipe is cost efficient, it may not perform well under extreme conditions. The foam insulation is surrounded and protected by a plastic casing; however over time the insulation tends to absorb water from the atmosphere. As the insulation absorbs water it becomes less efficient and new insulation is required. Sections of foam insulated copper pipe are typically joined by brazing or butt-welding and foam insulation is fitted around the joint.

Dynamic vacuum insulated pipe requires a vacuum system that is continuously running. While this pipe is more efficient than foam insulated pipe, there is an added cost of frequent pump maintenance and electrical power to run the pump(s). Additionally, if a vacuum pump fails then a whole pipe section may lose its vacuum, and hence its insulating properties becoming extremely inefficient.

Static vacuum insulated pipe is prefabricated and the vacuum is achieved and permanently sealed. One advantage of static insulated pipe is the equipment used to create the vacuum in the factory may be of better quality than equipment deployed in the field for use in a dynamic vacuum pipe. Static vacuum insulated pipe may however be susceptible to puncture; a punctured pipe may lose its vacuum and insulating properties and become extremely inefficient. Thermal loss may also occur at the joints because it is prefabricated and the joints may not be vacuum insulated.

### SUMMARY

In an embodiment, a temperature controlled pipe system comprises: at least one pipe section having (a) an outer pipe and (b) an inner pipe generally concentric to the outer pipe for transporting temperature sensitive fluid therethrough, the outer and inner pipes forming therebetween at least one temperature control space; such that transmission of temperature controlled fluid through the temperature control space influences temperature of the temperature sensitive fluid flowing through the inner pipe.

In an embodiment, a method is provided for controlling temperature of fluid transmitted through a pipe having (a) an inner pipe, (b) an outer pipe and (c) temperature control space formed between the inner pipe and outer pipe, comprising: transmitting the fluid through the inner pipe while transmitting temperature controlled fluid (e.g., gas, liquid) through the temperature control space.

### BRIEF DESCRIPTION OF THE FIGURES

FIG. 1A shows an exploded view of a prefabricated insulated pipe section.

FIG. 1B shows a top perspective view of a pipe section.

FIG. 2A shows an exploded view of a pipe joint.

FIG. 2B shows a top perspective view of pipe joint.

FIG. 3 shows an example a pipe system using pipe joints.

FIG. 4A shows cross-section of a pipe section.

FIG. 4B shows a perspective view of a punctured pipe section.

FIG. 5 shows a cross-section of a multi-chamber joint.

FIG. 6A and FIG. 6B show pipe sections with male and female threaded inter-connecting ends.

FIG. 7 shows an example of a threaded multi-chamber pipe system.

FIG. 8 shows an embodiment of a temperature controlled pipe system.

### DETAILED DESCRIPTION

A multi-chamber vacuum pipe system is described hereinbelow to provide a cost effective puncture-resistant insulated pipe and joint that may be produced and utilized in prefabricated sections. Other advantages will become more apparent in the following detailed description of the inventions.

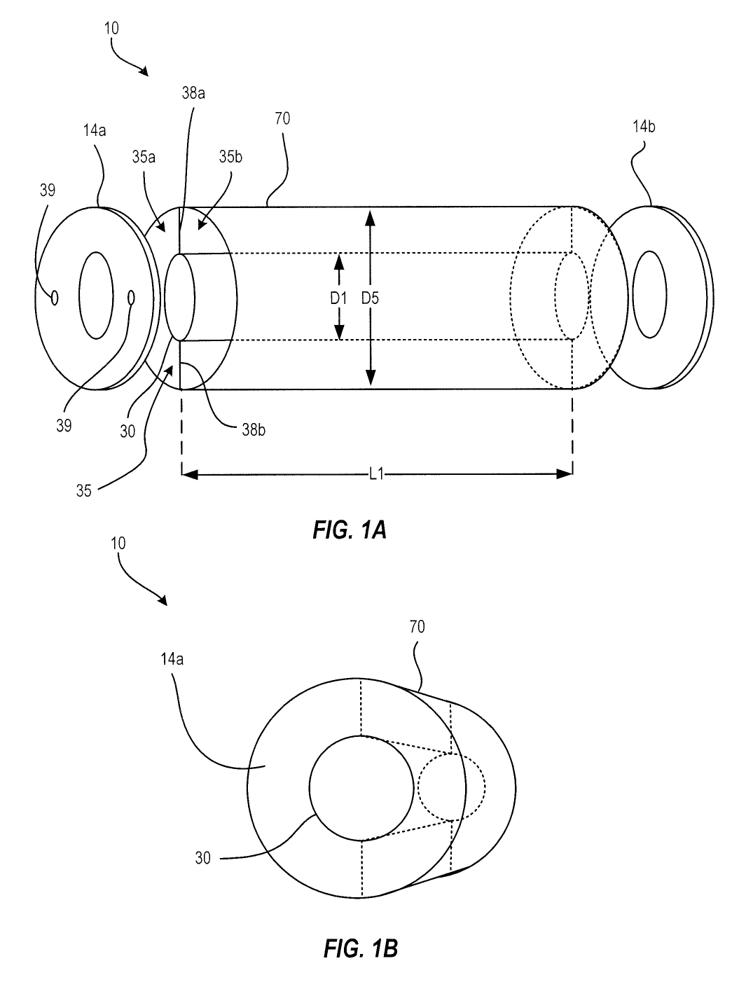

FIG. 1A shows an exploded view of a prefabricated insulated pipe section 10 with an inner pipe 30 for transporting temperature sensitive liquids and a concentric outer pipe 70, positioned such that an annular insulation space 35 is formed therebetween. Annular insulation space 35 is sealed by pipe end plates 14a and 14b at either end of pipes 30 and 70. The annular insulation space may be further dived into two pipe chambers 35a and 35b by chamber walls 38a and 38b, as shown. Outer pipe 70 may be made with thicker material than inner pipe 30 to increase puncture resistance of insulated pipe section 10. Pipe section 10 has a length L1, which may, for example, be between 0.1 m and 10 m, depending upon application. In one embodiment, insulated pipe section 10 is fabricated of hardened plastic; however in other embodiments insulate pipe section 10 may be constructed of ferrous or non-ferrous metal or of a metal plastic hybrid. Insulated pipe section 10 may, for example, be used to transport temperature sensitive liquids within inner pipe 30.

In one exemplary method of construction, outer pipe 70, inner pipe 30 and chamber walls 38a, 38b are formed by extrusion or any other appropriate method. Annular insulation space 35 is, for example, sealed at one end by pipe end plate 14a, air is removed therefrom, and pipe end plate 14b is then attached to seal insulation space 35 and maintain the vacuum therein. Vacuum sealing may occur within a vacuum chamber. Alternately, or additionally, after fitting of pipe end plates 14a, 14b to outer pipe 70, inner pipe 30 and chamber walls 38, one or more small hole 39 in pipe end plate 14a may be used to permit air to be withdrawn from insulation space 35; hole(s) 39 may then be sealed to maintain the vacuum within insulation space 35. The vacuum within insulation space 35 may be created by other means known in the art without departing from the scope hereof.

FIG. 1B shows a top perspective view of pipe section 10, in accord with one embodiment.

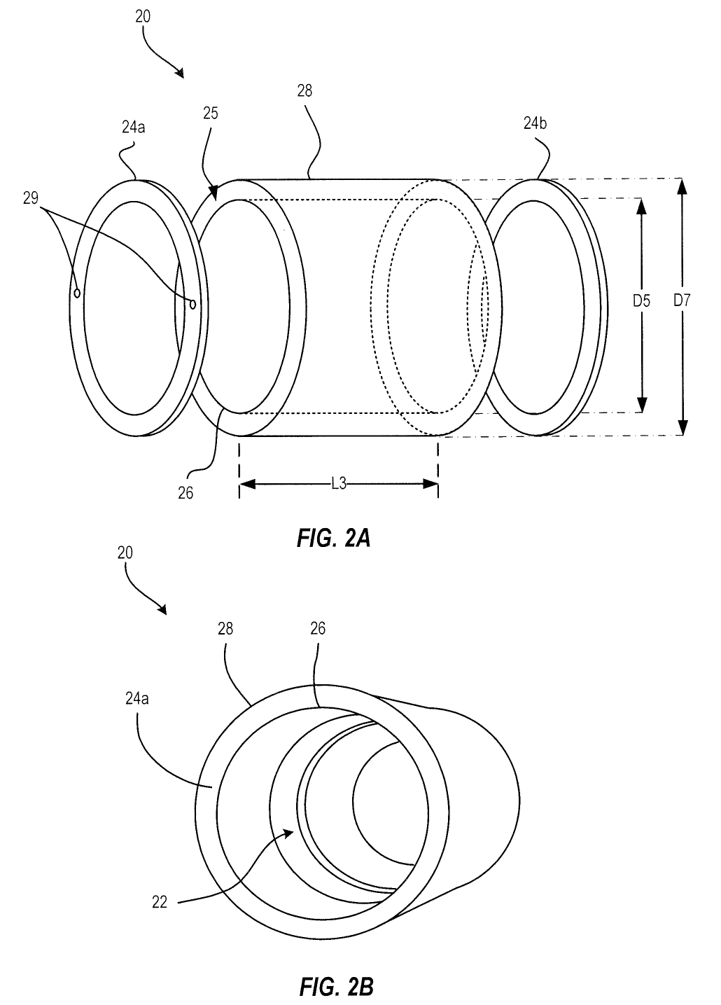

FIG. 2A shows an exploded view of one exemplary embodiment of an insulated pipe joint 20. Pipe joint 20 has an inner pipe 26 and an outer pipe 28 positioned such that an annular insulation space 25 is formed therebetween. Insulation space 25 is sealed by joint end plates 24a and 24b. Pipe joint 20 has a length L3, which may, for example, be between 0.1 m and 0.25 m, depending upon application. Inner pipe 26 has an internal diameter D5 so that pipe section 10 can slide into either side of joint 20 (i.e., through joint end plates 24a and 24b). Though not shown, insulation space 25 may be divided into multiple chambers by chamber walls.

In one exemplary method of construction, outer pipe 28 and inner pipe 26 are formed by extrusion or any other appropriate method. Insulation space 25 is, for example, sealed at one end by joint end plate 24a, air is removed therefrom, and joint end plate 24b is then attached to seal insulation space 25 and maintain the vacuum therein. Vacuum sealing may occur within a vacuum chamber. Alternately, or additionally, after fitting of joint end plates 24a, 24b to outer pipe 28 and inner pipe 26, one or more small hole 29 in joint end plate 24a may be used to permit air to be withdrawn from insulation space 25; hole(s) 29 may then be sealed to maintain the vacuum within insulation space 25. The vacuum within insulation space 25 may be created by other means known in the art without departing from the scope hereof.

FIG. 2B shows a perspective view of pipe joint 20 of FIG. 2A once assembled. Pipe joint 20 may also include a pipe stop 22, as shown in FIG. 2B, that prevents pipe section 10 from passing more than halfway through pipe joint 20 during insertion. Pipe section 10 and pipe joint 20 may be attached using pipe adhesive or other methods known in the art; the method employed may be selected to prevent thermal leakage. Pipe stop 22 may protrude at least partially along the circumference of inner pipe 26 in the center of pipe joint 20. In other embodiments, pipe stop 22 may be formed as a gradual reduction in the diameter of inner pipe 26 towards the center of inner pipe 26.

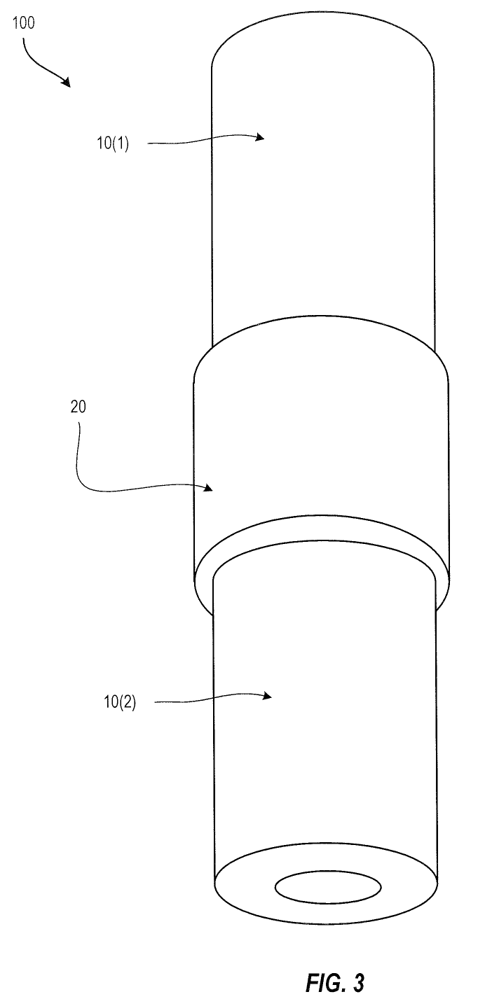

FIG. 3 shows one exemplary pipe system 100 with two pipe sections 10 (labeled 10(1) and 10(2), respectively) and a pipe joint 20. Although shown with two pipe sections 10 and one pipe joint 20, pipe system 100 may contain additional pipe sections 10 and joints 20 to form a longer insulated section of pipe. It should be appreciated that one or more pipe section 10 and/or pipe joint 20 may be nonlinear (e.g., curved, angled, etc.) and that the resultant pipe system may therefore be nonlinear.

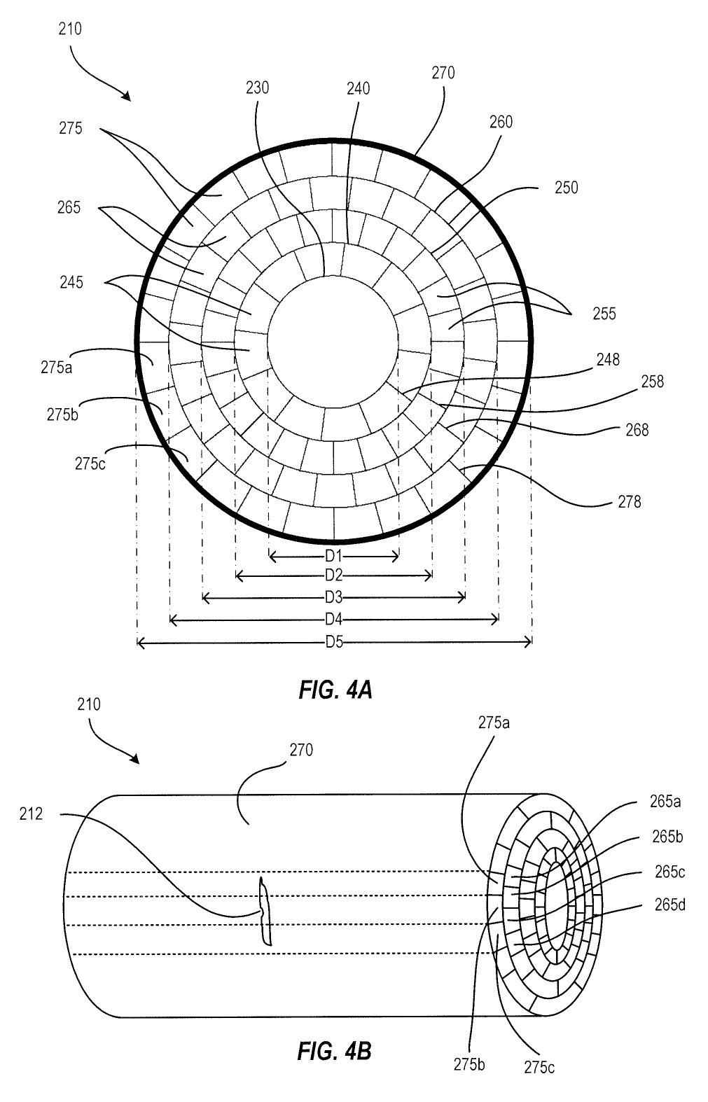

FIG. 4A shows a cross-section through one exemplary embodiment of a pipe section 210. Pipe section 210 may, for example, represent pipe section 10 (FIG. 1A). Pipe section 210 is, for example, formed with an outer pipe 270 and four concentric inner pipes 260, 250, 240, and 230 to form insulating spaces 275, 265, 255, and 245. Pipes 230, 240, 250, 260, and 270 are generally concentric and are shown with diameters D1, D2, D3, D4, and D5, respectively. Insulating spaces 275, 265, 255, and 245 may be divided into sub-spaces by chamber walls 278, 268, 258, and 248, respectively.

Outer pipe 270 may, for example, be made of thicker material than inner pipes 260, 250, 240, and 230 and walls 278, 268, 258, and 248 to increase puncture resistance of pipe section 210. Though not specifically shown, an additional outer casing may be formed around pipe section 210 in increase durability of pipe section 210. Some embodiments may include variation in thickness of inner pipes 260, 250, 240, and 230 and/or walls 278, 268, 258, and 248 without departing from the scope hereof.

Pipe section 210 may include pipe end plates (not shown) that seal insulating spaces 275, 265, 255 and 245; these end plates may, for example, be similar to end plates 14a, 14b of FIG. 1A. Air may be evacuated from insulating spaces 275, 265, 255 and 245 to improve insulation of fluids transported within inner pipe 230. Each sub-space of insulating spaces 275, 265, 255 and 245 (e.g., sub-spaces 275a, 275b, 275c, etc.) may be sealed to prevent fluid flow between sub-spaces. The number of insulating spaces and sub-spaces may vary without departing from the scope hereof. In some embodiments, insulating spaces 275, 265, 255 and 245 have equal vacuum. In other embodiments, vacuum within insulating spaces 275, 265, 255 and 245 varies; for example, vacuum may increase towards the center of pipe section 210.

Pipe section 210 may be rated based upon its insulation properties and the material from which it is constructed. For example, pipe section 210 may be used to transport water through a mountainous environment prone to temperatures 20 degrees Celsius (C) below the freezing point of water and therefore requires that pipe section 210 be rated for −20° C. In another example, pipe section 210 may transport water through an environment that has lesser extremes and therefore need only be rated for −10° C. To achieve lower temperature ratings (e.g., −20° C.), pipe section 210 may have more internal pipes (e.g., internal pipes 230, 240, 250 and 260) and additional sub-spaces within each insulating space (e.g., sub-spaces 275a, 275b, and 275c within insulating space 275). Vacuum properties of pipe section 210 (e.g., gas pressure between the exterior pipe 270 and the inner pipe 230) may also be altered to achieve different temperature ratings.

In some embodiments, pipes 230, 240, 250, 260, and 270 and chamber walls 278, 268, 258, and 248 are formed from plastic using extrusion molding techniques. In other embodiments, outer pipe 270 and insulating spaces 275, 265, 255, and 245 are formed separate from inner pipe 230 and are then later attached to inner pipe 230.

FIG. 4B shows a perspective view of pipe section 210 of FIG. 4A with a puncture 212 that breaches exterior pipe 270. In particular, puncture 212 breaches sub-spaces 275a, 275b, and 275c of insulating space 275, but has not breached pipe 260 or other sub-spaces within insulating space 275. Therefore, in this example, other sub-spaces of insulating space 275, insulating space 265 (e.g., sub-spaces 265a, 265b, 265c and 265d), insulating space 255, and insulating space 245 still maintain a vacuum and provide insulation in the region of puncture 212. Since puncture 212 has only compromised external pipe 270 and sub-spaces 275a, 275b, and 275 of insulating space 275, it may not be necessary to replace pipe section 210 since inner pipe 230 may still be sufficiently insulated.

Since each sub-space within each insulating space may have an individual vacuum, a non-catastrophic puncture (e.g., puncture 212) may not compromise the insulation of pipe section 210. Further, pipe section 210 may tolerate a certain number of chamber failures over a certain distance and still maintain sufficient insulation of inner pipe 230.

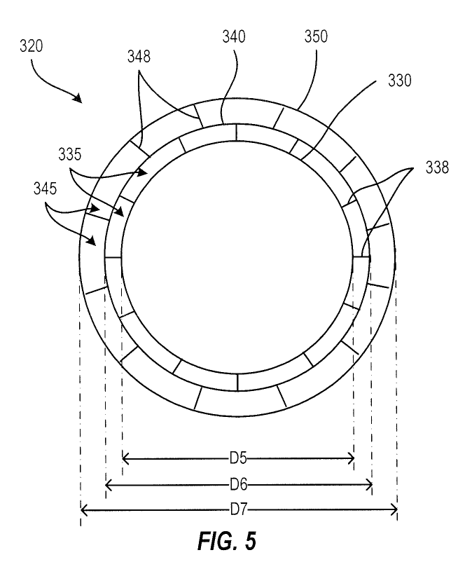

FIG. 5 shows a cross-section through one exemplary embodiment of a pipe joint 320. Pipe joint 320 may, for example, represent pipe joint 20 of FIG. 2A. Pipe joint 320 is shown with three concentric pipes 350, 340, and 330 that form insulating spaces 345 and 335 therebetween. Insulating spaces 345 and 335 are each subdivided into sub-spaces by walls 348 and 338, respectively.

Outer pipe 350 may be made of thicker material to increase puncture resistance; however, pipes 350, 340, and 330 may vary in thickness without departing from the scope hereof. Each sub-space of insulating spaces 335 and 345 may contain a vacuum to increase insulation properties. Since each sub-space may be individually sealed, one or more punctures to outer pipe 350 may not compromise insulation of inner pipe 330.

Concentric joint pipes 340, 350, and 360 have diameters D5, D6, and D7, respectively. The inner diameter D5 of inner pipe 330 allows pipe section 210 to fit therein. In one example, pipe section 210 and joint 320 fit together snugly; force and/or adhesive, for example, may be used to facilitate joining pipe section 210 and pipe joint 320.

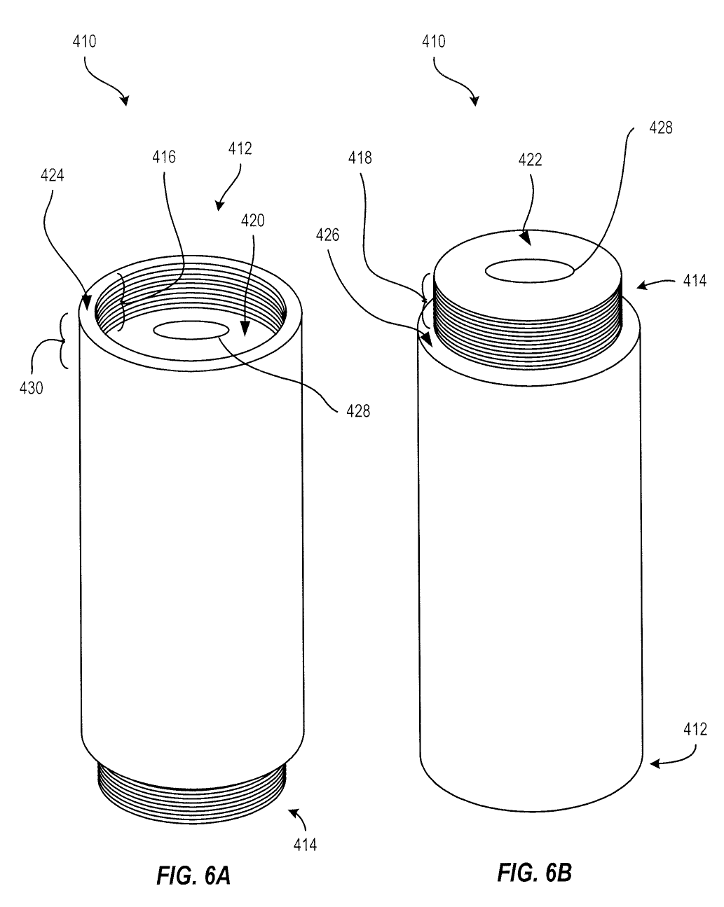

FIG. 6A shows one exemplary embodiment of a pipe section 410 with female 412 and male 414 inter-connecting ends. FIG. 6B shows pipe section 410 inverted for clarity of illustration of male end 414. FIGS. 6A and 6B are best viewed together with the following description.

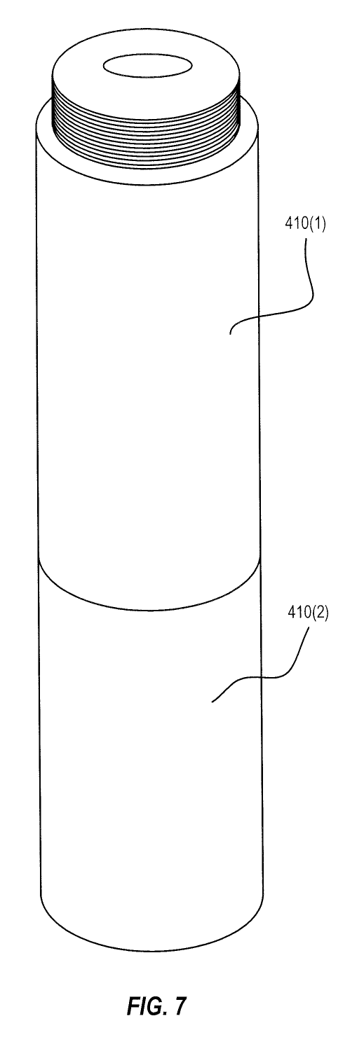

Female end 412 is shown with a female thread 416, and male end 414 is shown with a male thread 418. FIG. 7 shows multiple pipe sections 410 (labeled 410(1) and 410(2), respectively) connected together by threads 416, 418. When so connected, surface 420 and surface 424 of female end 412 (FIG. 6A) meets surface 422 and surface 426 of male end 414 (FIG. 6B), respectively, such that inner pipe 428 allows unimpeded fluid flow between pipe sections. Female thread 416 may, for example, be formed on an inner wall of an outer pipe (e.g., outer pipe 270, FIG. 4A) of a pipe section (e.g., pipe section 210), or may be formed on an inner pipe (e.g., inner pipe 260, FIG. 4A) such as to include insulation (e.g., insulation space 275) around female tread 416. Male thread 418 may be formed upon an external wall of an inner pipe (e.g., inner pipe 260, FIG. 4A) such as to include insulation (e.g., insulating spaces 265, 255, 245) between male thread 418 and inner pipe 428. Thus, when connected (FIG. 7), the insulation properties of multiple pipe sections 410 may be continuous. Adhesive may be used to on threads 418 and/or threads 416 to ensure pipe sections 410 remain connected.

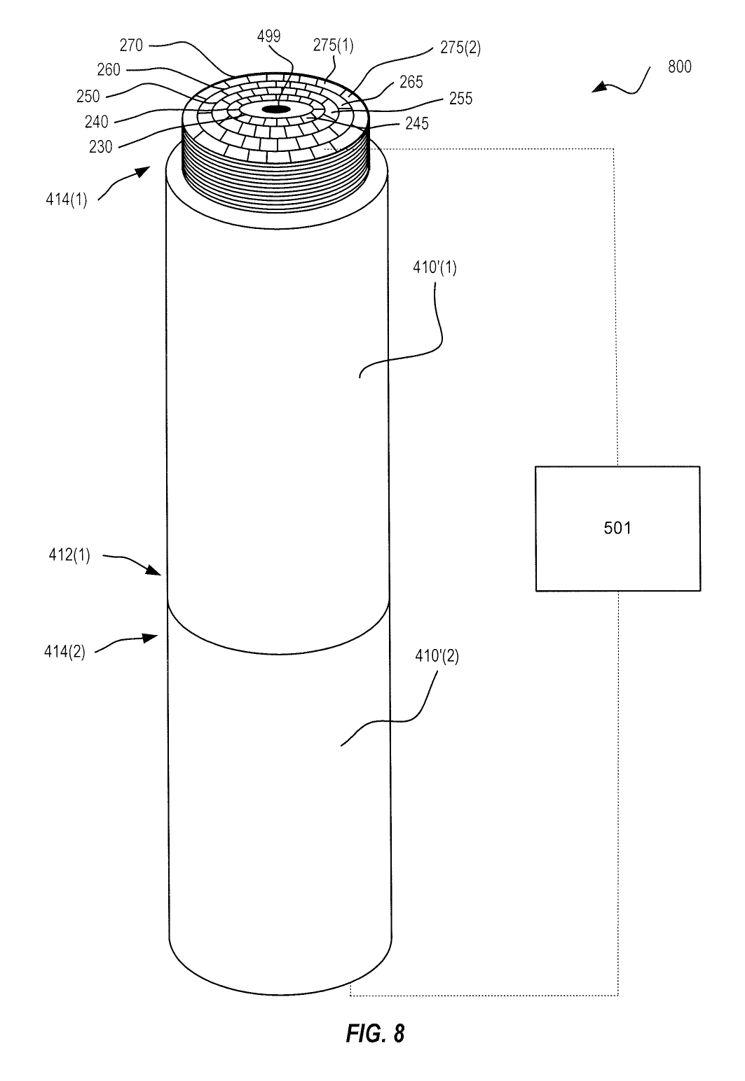

FIG. 8 shows a temperature controlled pipe system 800. System 800 has pipe sections 410′ (1) and 410′(2), but may have a different number of pipe sections 410′ as desired. Female end 412′ and male end 414′ inter-connect similar to female end 412 and male end 414 of FIG. 6. As above, system 800 includes at least one inner pipe 240, 250, 260, 270 and at least one formed temperature control space 245, 255, 265, 275. Pipes 230, 240, 250, 260, and 270 may be thermally coupled or thermally insulated. Spaces 245, 255, 265, and 275 of pipe section 410′(2) align so as to allow a temperature controlled fluid (e.g., air, gas and/or liquid) contained therein to flow unimpeded to spaces 245, 255, 265, and 275 of pipe section 410′(1). The configuration between female end 412′ to male end 414′ allows for the temperature controlled fluid to flow through the length of pipe system 800 (which again may be comprised of a different number of pipe sections 410′).

In operation, spaces 245, 255, 265, and 275 are for example filled with temperature conditioned air, gas and/or liquid to control the temperature within pipe 230. A temperature measuring device 499 may be thermally coupled with pipe 230, or suspended stationary in the flow within pipe 230. Temperature measuring device 499 monitors the temperature of the temperature controlled fluid (e.g., water) contained in pipe 230.

In one embodiment, the temperature controlled fluid are controlled in a “closed” system. In this closed system, for example, conditioned air, gas or liquid is recycled. The conditioned air, gas or liquid for example enters pipe 240, 250, and 260 at a first end of pipe system 800, absorbs heat from pipe 230 during thermal transfer therein, and exits a second end of pipe system 800; the air, gas or liquid is then temperature reconditioned before reentering the first end of pipe system 800 (forming the “closed” system). Pipe 270 may be evacuated to insulate pipes 230, 240, 250 and 260 from the surrounding environment.

In an embodiment, system 800 is controlled at each pipe section 410′ to further condition the air, gas or liquid within the closed system. For example, the air, gas or liquid enters a pipe 240, 250, 260 and 270 at a first end of pipe section 410′(1), absorbs heat from pipe 230, exits a second end of pipe section 410′(1); then this air, gas or liquid is temperature reconditioned and reentered into the first end of pipe section 410′(1). This embodiment gives finer temperature control of the substance (e.g., water) within pipe 230 at each section 410′ of system 800.

The flow of air, gas and/or liquid in pipes 240, 250, 260, and 270 may be parallel or anti-parallel to the flow in pipe 230. Furthermore, the flow of temperature controlled fluid in pipe 240, 250, 260, and 270 may be parallel or anti-parallel to the flow of temperature controlled fluid in the adjacent pipe 240, 250, 260, and 270. Still further, the temperature controlled fluid in a space, for example space 275(1), may be parallel or anti-parallel to flow of an adjacent space, for example space 275(2).

To maintain a consistent temperature in pipe 230, a temperature control system 501 (e.g., a refrigeration unit) may monitor the temperature of pipe 230 via input from temperature measuring device 499. Temperature control system 501 adjusts the temperature of the conditioned air, gas and/or liquid piped into spaces 245, 255, 265, and 275 as needed to control the temperature of the substance in pipe 230. In an example of operation, water is the conditioned liquid piped through spaces 245, 255, 265 and/or 275, and measuring device 499 thermally couples with pipe 230 to measure a temperature that is above the specified temperature. Temperature control system 501 decreases the temperature of the water piped into spaces 245, 255, 265, and 275 thereby decreasing the temperature of the substance in pipe 230 via thermal coupling.

Changes may be made in the above systems and methods without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A temperature controlled pipe system, comprising:
at least one pipe section having:
an outer pipe; and
an inner pipe generally concentric to the outer pipe for transporting temperature sensitive fluid therethrough, the outer and inner pipes forming therebetween at least one temperature control space;
such that transmission of temperature controlled fluid through the temperature control space influences temperature of the temperature sensitive fluid flowing through the inner pipe.

2. The temperature controlled pipe system of claim 1, the temperature control space comprising a plurality of temperature control spaces.

3. The temperature controlled pipe system of claim 2, wherein transmission of the temperature controlled fluid occurs through the plurality of the control spaces.

4. The temperature controlled pipe system of claim 3, further comprising temperature controlled fluid transmitted bidirectionally or unidirectionally through the plurality of the control spaces.

5. The temperature controlled pipe system of claim 3, the temperature controlled fluid comprising one or more of air, gas, liquid.

6. The temperature controlled pipe system of claim 1, further comprising a temperature monitoring device coupled with the inner pipe to measure temperature of the temperature controlled fluid.

7. The temperature controlled pipe system of claim 6, further comprising a temperature controlling system for controlling the temperature of the temperature control fluid.

8. The temperature controlled pipe system of claim 6, the temperature monitoring device sensing, indirectly or directly, temperature of the temperature controlled fluid.

9. The temperature controlled pipe system of claim 1, further comprising a plurality of like pipe sections connected together in general alignment of the inner and outer pipe and temperature control space.

10. The temperature controlled pipe system of claim 9, further comprising at least two temperature control fluids, at least one fluid flowing through each pipe section to separately adjust temperature of the temperature controlled fluid passing therethrough.

11. A method for controlling temperature of fluid transmitted through a pipe having (a) an inner pipe, (b) an outer pipe and (c) temperature control space formed between the inner pipe and outer pipe, comprising:
transmitting the fluid through the inner pipe while transmitting temperature controlled fluid through the temperature control space.

12. The method of claim 11, further comprising measuring temperature of the fluid in, on or near to the inner pipe.

13. The method of claim 12, further comprising comparing the measured temperature to a desired temperature; and controlling the temperature of the temperature controlled fluid to adjust the temperature of the fluid towards the desired temperature.

14. The method of claim 11, wherein the temperature control space comprises a plurality of control spaces, further comprising transmitting a plurality of temperature control fluids through the control spaces.

15. The method of claim 11, wherein the pipe comprises a plurality of pipe sections, further comprising separately adjusting temperature of temperature controlled fluid through the temperature control space of each pipe section to separately adjust temperature of the fluid at each pipe section.

16. The method of claim 11, the temperature controlled fluid comprising one or more of gas, liquid, air.
